(19) United States
(12) Patent Application Publication
(10) Pub. No.: US 2024/0397270 A1
(43) Pub. Date: Nov. 28, 2024

(54) HEARING DEVICE SYSTEM

(71) Applicant: Sivantos Pte. Ltd., Singapore (SG)

(72) Inventors: Subhasri MITRA, Erlangen (DE); Andreas PFROMMER, Erlangen (DE)

(21) Appl. No.: 18/675,417

(22) Filed: May 28, 2024

(30) Foreign Application Priority Data
May 26, 2023 (DE) 10 2023 204 980.5

(51) Int. Cl. H04R 25/00

(52) U.S. Cl. CPC H04R 25/554; H04R 2225/55

(57) ABSTRACT

Each of a hearing device and a mobile terminal of a hearing device system has a wideband communications apparatus, a narrowband communications apparatus, and a controller. The mobile terminal further has a position detection system. The controllers establish and maintain a narrowband connection between the hearing device and the mobile terminal during normal operation. When the narrowband connection is disconnected, the mobile terminal determines and stores its current position as a loss position of the hearing device using the position detection system. The stored loss position is displayed to a user in a search mode and a wideband connection is established via the wideband communications apparatus. The actual position of the hearing device is derived and output to the user based of the wideband connection. A charger of the hearing device may be found in the same way as the hearing device.

The invention relates to a hearing device system.

Hearing devices are typically used to output an audio signal to the sense of hearing of the wearer of this hearing device. The output takes place by means of an output transducer, usually acoustically via airborne sound by means of a loudspeaker (also referred to as a “receiver”). Such hearing devices are frequently used as so-called hearing aid equipment (also in short: hearing aids).

For this purpose, the hearing devices normally comprise an acoustic input transducer (in particular a microphone) and a signal processor, which is configured to process the input signal (also: microphone signal) generated from the ambient sound by the input transducer using at least one signal processing algorithm, which is usually stored in user-specific fashion, the processing being such that a reduced hearing of the hearing device wearer is at least partially compensated. In particular in the case of hearing aid equipment, the output transducer can be, in addition to a loudspeaker, alternatively also a so-called bone vibrator or a cochlear implant, which are configured for mechanical or electrical coupling of the sound signal into the sense of hearing of the wearer. The term hearing devices also additionally includes in particular equipment such as, e.g., so-called tinnitus maskers, headsets, headphones, and the like.

Typical designs of hearing devices, in particular hearing aids, are behind-the-ear (“BTE”) and in-the-ear (“ITE”) hearing devices. These designations are indicative of the intended wearing position. For example, behind-the-ear hearing devices have a (main) housing that is worn behind the ear cup. In this context, a distinction can be made between models whose loudspeaker is arranged in this housing—in this case, the sound is typically output to the ear by means of a sound tube worn in the auditory canal—and models comprising an external loudspeaker which is placed in the auditory canal. In-the-ear hearing devices, on the other hand, have a housing that is worn in the ear cup or even entirely in the auditory canal.

What is common to hearing devices, in particular hearing aid equipment, is that these—like many other products—are subject to miniaturization, especially to allow wear that is as inconspicuous as possible. Their weight is also continually reduced in the process. However, this increases the risk of a hearing device loss often not being noticed immediately and/or of these devices only being retrievable with difficulties.

The problem addressed by the invention is that of facilitating a hearing device retrieval.

According to the invention, this problem is solved by a hearing device system having the features of claim 1. Further embodiments and developments of the invention that are advantageous and are also in some cases in themselves inventive are stated in the dependent claims and in the following description.

The hearing device system according to the invention comprises a hearing device having a first wideband communications apparatus, a first narrowband communications apparatus, and a first controller interconnected therewith. That is to say, the first controller is linked (in particular for data transmission) to the first wideband communications apparatus and to the first narrowband communications apparatus. The hearing device system also comprises a mobile terminal having a second wideband communications apparatus, a second narrowband communications apparatus, a position detection system, and a second controller interconnected therewith. In this case, the first and the second controller are configured to establish and maintain a narrowband connection (in particular for two-way communication) between the hearing device and the mobile terminal by means of the first and the second narrowband communications apparatus during an intended normal operation (of the hearing device system). The second controller is configured to determine and store a current position of the mobile terminal as loss position of the hearing device using the position detection system if the narrowband connection with the hearing device is disconnected. Moreover, the second controller is configured to display the stored loss position to a user, at least in a search mode activated by a user input. Further, the second controller is configured within the scope of the search mode to establish a wideband connection with the hearing device by means of the second wideband communications apparatus and derive and output to the user an indication for an actual position of the hearing device on the basis of this wideband connection.

By preference, the indication and/or the loss position is indicated optically, with the loss position in particular being displayed by means of a (digital) map, preferably on a display of the mobile terminal, which might be formed by a smartphone for example.

In the present case, an indication for presence or absence of the hearing device is therefore derived by the second controller on the basis of the narrowband connection. In particular, the indication is based on whether the narrowband connection is established or not, and so the presence of the hearing device is deduced if the narrowband connection is established. Accordingly, the absence of the hearing device—or at least a position of the hearing device outside of the (connection) range of the narrowband connection—is deduced if the narrowband connection is not (no longer) established. If an absence of the hearing device is identified, then the current position of the mobile terminal is stored accordingly as the loss position of the hearing device. In this context, the use of the narrowband connection is advantageous in that such a connection with a mobile terminal often exists in any case for modern hearing devices, for example so as to be able to enter control inputs into the mobile terminal and transmit these to the hearing device. Thus the hearing device and the terminal form the above-described hearing device system. Thus an advantageous multiple use of the narrowband connection is present in this case. The position of the terminal at the time when the absence of the hearing device was recognized, stored as loss position, may in this case form an advantageous starting point if a search for the hearing device is started at a later time (or even immediately, for example if the first controller advantageously outputs an alert in addition to the determination of the loss position).

In an advantageous development, the second controller is configured to already deduce the absence of the hearing device (and accordingly determine and store the loss position) if the hearing device is (still) within the connection range of the narrowband connection (i.e., the narrowband connection is still established) but a distance value greater than a specified limit value (e.g., two or 1.5 meters) is determined between the mobile terminal and the hearing device by way of the narrowband connection. This distance value is determined by the second controller, in particular on the basis of the signal strength of a signal received by the hearing device. This procedure is expedient, especially for cases in which the narrowband connection can be maintained over a distance of, e.g., more than three, four or five meters (in the case of a clear transmission path) as a matter of principle.

In an advantageous embodiment, the second controller is configured within the scope of the search mode—especially if the narrowband connection is no longer established—to reestablish the narrowband connection between the hearing device and the mobile terminal by means of the second narrowband communications apparatus if the mobile terminal is situated within a given range around the determined loss position. In particular, the second controller is configured to transmit a query signal within this range, for example three to five meters, the query signal triggering the first controller upon reception to attempt (and, if possible, also perform) coupling with the second narrowband communications apparatus (i.e., reestablish the narrowband connection) by means of the first narrowband communications apparatus in the hearing device.

In an advantageous development, the second controller is configured to derive an approximate indication for the actual position of the hearing device on the basis of the narrowband connection. In particular, once the narrowband connection has been reestablished within the scope of the search mode, the second controller thus determines the magnitude of the distance between the terminal and the hearing device using this narrowband connection, especially on the basis of the detected signal strength of a signal from the hearing device (i.e., the first narrowband communications apparatus thereof). Since a distance determination on the basis of the signal strength is often subject to comparatively large uncertainty on account of environmental influences (e.g., signal-attenuating “obstacles” in the signal path), the distance (or the separation) determined thus is used as an approximate indication in this context.

In addition to the aforementioned information relating to the separation (“separation information”; or relating to the distance value) of the terminal from the hearing device, directional information is preferably also additionally determined and output as indication and/or approximate indication. For example, the directional information can be determined by virtue of the user of the mobile terminal and the hearing device being requested by the terminal (specifically its controller) to extend the terminal in front of them (e.g., by audio output or on-screen display) and rotate about their own axis (e.g., at least once). As a result, the terminal at least sweeps over approximately a circle (or a partial circle in the case of an incomplete rotation), with the result that the separation from the hearing device varies over the rotation. The rotational position with the smallest determined separation can then be used as directional information.

In an advantageous embodiment, the second controller is configured within the scope of the search mode to establish the wideband connection following a user-specific input. Thus, especially if the hearing device is no longer retrievable on the basis of the narrowband connection, the user is able by means of an input on the mobile terminal to request the establishment of the wideband connection with the hearing device, i.e., specifically between the first and the second wideband communications apparatus, and the use of this wideband connection for the further search.

Especially in the embodiment of the wideband connection only being established following a user-specific input, the second controller is configured according to a preferred embodiment and within the scope of the search mode to transmit a trigger signal to the hearing device by means of the narrowband connection, for the purpose of establishing the wideband connection. The first controller is preferably configured to activate the first wideband communications apparatus following the reception of this trigger signal and thus allow the wideband connection to be established. Optionally (in addition to that or in an alternative), however, the trigger signal can also be output in time-controlled fashion if the second controller determines a high probability of the hearing device not yet being retrieved on the basis of the narrowband connection and, moreover, a specified period having elapsed. For instance, this can be implemented by a timer (e.g., five, ten, 15 or even 20 minutes) being started once the search mode has been adopted, the second controller continuing to determine the distance from the hearing device during this time and deducing that the hearing device has not been found if the determined distance value is more than, e.g., 50 cm or one meter (or if such a small distance value is only present for a short duration of, e.g., less than 30 seconds, for example if the terminal comes into the vicinity of the hearing device during the search, but the user nevertheless does not see the latter).

In a preferred embodiment, the first and the second narrowband communications apparatus are configured to operate according to radio technology referred to as Bluetooth Low Energy. This radio technology is distinguished by particularly low power consumption.

In a preferred embodiment, the first and the second wideband communications apparatus are configured to transmit signals with a frequency width of at least 500 MHz and/or at least 20% of a mid-frequency of the signals, in particular with a pulse duration of less than or equal to 3 ns. Such a wideband communication is also referred to as ultrawideband communication or “UWB” communication.

Consequently, the first and the second wideband communications apparatus are ultrawideband or “UWB” communications apparatus. Accordingly, the respective wideband connection is an ultrawideband (UWB) connection. In this context, the mid-frequency should be understood to mean, in particular, the mean value of the upper and lower limit frequency of the corresponding frequency band. By contrast, conventional radio technology provided for such uses (narrowband radio or narrowband communication) uses significantly narrower frequency widths, in particular frequency widths measured as less than half of this (for example, WLAN with at most approximately 160 MHz in the 5 GHz band, otherwise less than 100 MHz; Bluetooth likewise below 100 MHZ). Moreover, the first and the second wideband communications apparatus are preferably configured to transmit only individual signal pulses (preferably in the range of less than 10 ns, in part of the order of 1 ns). In contrast to conventional radio technology (in particular WLAN and Bluetooth), there is no modulation of a carrier signal, specifically its carrier frequency, here; instead, use is made of pulse modulation techniques in particular.

Preferably, the second controller is configured, optionally the first and the second controller are configured, to determine the distance between the terminal and the hearing device on the basis of a signal time-of-flight measurement. A wideband connection is particularly suitable to this end since particularly short pulse durations in comparison with the narrowband connection are possible on account of the wideband signals. These short pulse durations in turn allow a comparatively precise determination of separations on the basis of the signal time-of-flight measurement. In principle, the determination of directional information in accordance with the above-described procedure for the narrowband connection (rotation about the own axis) can also be implemented by means of the wideband connection. In this context, swiveling through, e.g., 45 to 90 or 180 degrees about the own axis may also optionally already be sufficient here on account of the comparatively higher spatial resolution of the wideband connection.

Alternatively, the second controller is configured, optionally the first and the second controller are configured, to determine the distance between the terminal and the hearing device on the basis of a so-called signal angle of arrival of a signal transmitted within the scope of the (ultra) wideband connection. In particular, this can be used whenever the hearing device and/or the mobile terminal comprise two (ultra) wideband communications apparatus or at least two (ultra) wideband antennas. In this case, the distance of the transmitter can be deduced on the basis of, for example, a phase shift of the signal captured by means of these two communications apparatus or antennas.

In a further expedient embodiment, which also represents an invention on its own, the hearing device system comprises a charger for the hearing device in addition to the above-described hearing device and also in addition to the terminal. In this case, the hearing device advantageously has a rechargeable battery. In a manner comparable to the above-described hearing device and terminal, the charger comprises a third wideband communications apparatus (which is preferably also configured and constructed in a manner comparable to the above-described (ultra) wideband communications apparatus), a third narrowband communications apparatus, and a third controller interconnected therewith. In this case, the second and the third controller are configured to interact with one another in accordance with the procedure described above in relation to the first and the second controller. Expressed differently, the second and the third controller are thus configured to establish and maintain a narrowband connection between the mobile terminal and the charger by means of the second and the third narrowband communications apparatus during an intended normal operation (of the hearing device system). The second controller is configured to determine and store a current position of the mobile terminal as loss position of the charger using the position detection system if the narrowband connection with the charger is disconnected. Moreover, the second controller is configured to display the stored loss position (of the charger) to the user, at least in a search mode activated by a user input. Further, the second controller is configured within the scope of the search mode to establish a wideband connection with the charger by means of the second wideband communications apparatus and derive and output to the user an indication for an actual position of the charger on the basis of this wideband connection.

Within the scope of an independent invention, the hearing device in the above-described case may also be equipped without the wideband communications apparatus, and optionally also without the narrowband communications apparatus. Thus, in this case the hearing device system is only configured to retrieve the charger by means of the above-described search mode.

Thus, in particular, the third controller is configured to provide and optionally execute the above-described functionality for the possibly required search for the charger in a manner analogous to the first controller (of the hearing device). The second controller is accordingly configured to analogously also execute the functionality for searching and finding the hearing device, as described above for the second controller, for searching and finding the charger. The third controller, the third narrowband communications apparatus, and also the third wideband communications apparatus thus have the same above-described features and advantages as the first controller, the first narrowband communications apparatus, and the first wideband communications apparatus.

By preference, at least one software application is executably installed on the second controller, said software application configuring the mobile terminal upon execution on the second controller to perform the above-described steps, in particular automatically but optionally also in conjunction with the user. In particular, this software application is programmed for the realization of the above-described search mode. Optionally, a further software application is directed to the determination of the presence or absence of the hearing device or charger during the normal operation.

The conjunction “and/or” here and in the following is to be understood, in particular, to mean that features linked by means of this conjunction can be implemented both jointly and as alternatives to each other.

Exemplary embodiments of the invention are explained in more detail below with the aid of a drawing. In the figures:

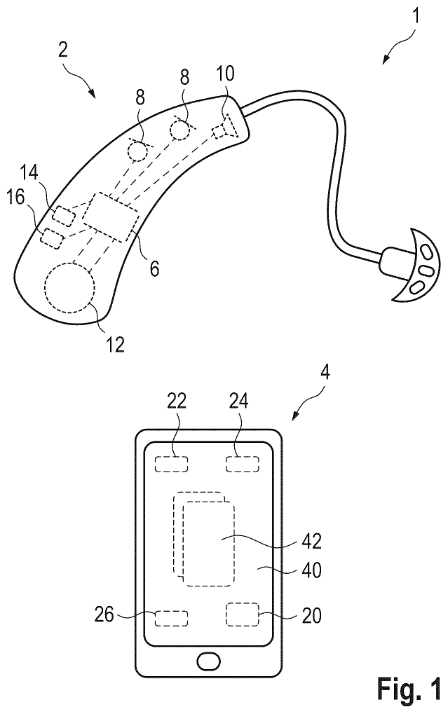

FIG. 1 shows a schematic drawing of a hearing device system,

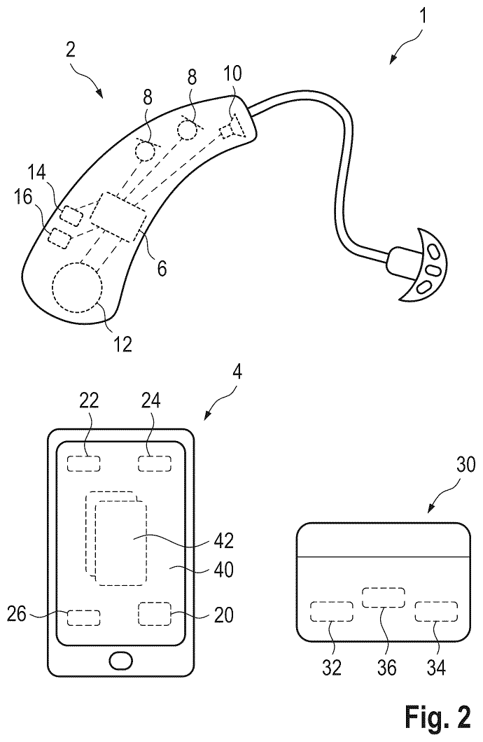

FIG. 2 shows a further exemplary embodiment of the hearing device system in view according to FIG. 1, and

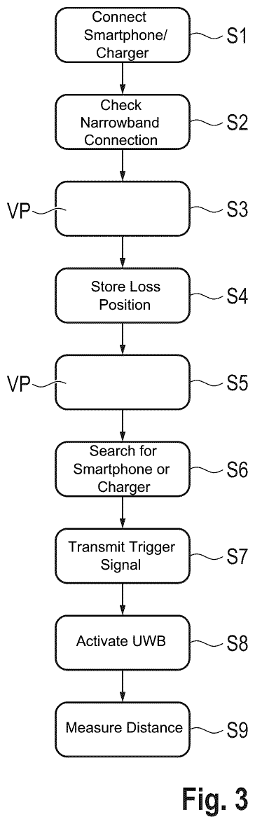

FIG. 3 shows a schematic flowchart of a method performed by the hearing device.

Parts corresponding to one another are always provided with the same reference signs in all figures.

FIG. 1 schematically illustrates a hearing device system 1. The latter comprises a hearing device 2 (specifically in the form of hearing aid equipment) and a mobile terminal, specifically in the form of a smartphone 4 in this case. The hearing device 2 comprises a signal processor 6 as a first controller and two microphones 8, a loudspeaker 10 and an (e.g., rechargeable) battery 12 as further electronic and electrical components. As further components, the hearing device 2 moreover comprises a first narrowband communications apparatus in the form of a Bluetooth Low Energy module (“BLE module 14”) and a first ultrawideband communications apparatus (“UWB module 16”), which are likewise interconnected with the signal processor 6 for data transmission.

The smartphone 4 comprises a controller 20, a (second) BLE module 22 as a second narrowband communications apparatus, a (second) UWB module 24 as a second ultrawideband communications apparatus, and a position detection system 26, which are interconnected (not depicted in more detail here) with the controller 20 for data transmission.

FIG. 2 depicts a further exemplary embodiment of the hearing device system 1. In addition to the hearing device 2 and the smartphone 4, the hearing device system 1 also comprises a charger 30 in this case. The charger 30 comprises a third controller 32 and a (third) BLE module 34 as a third narrowband communications apparatus and a (third) UWB module 36 as a third ultrawideband communications apparatus. In an optional variant of this exemplary embodiment, the hearing device 2 according to FIG. 2 is configured without the UWB module 16 (and optionally without the BLE module 14).

FIG. 3 schematically describes a method performed by the hearing device system 1 of the configuration according to FIG. 1 in more detail. In a first method step S1, the signal processor 6 and the controller 20 of the smartphone 4 establish and maintain a narrowband connection by means of the respective BLE module 14 and 22, respectively, during an intended normal operation of the hearing device system 1. In a second method step S2, the controller 20 carries out a check as to whether there still is the narrowband connection between the hearing device 2 and the smartphone 4 (specifically between the two BLE modules 14 and 22, respectively) or whether said connection has been disconnected.

If the narrowband connection no longer exists, then the controller 20 of the smartphone 4 determines a current position and sets the latter as loss position VP by means of the position detection system 26 (e.g., in satellite-based fashion) in a third method step S3. In a fourth method step S4, the second controller 20 stores the loss position VP in a data memory (not depicted here) of the smartphone 4. Optionally, the second controller 20 also outputs an alert, optically via a display 40 of the smartphone 4 and/or acoustically.

The second controller 20 adopts a search mode in a fifth method step S5. This can be implemented automatically on account of the absence of the hearing device 2, identified as described above, or on the basis of a user input. For instance, the user of the hearing device 2 can start the search mode in an application 42 installed on the smartphone 4 when they themselves notice the absence of said hearing device. Within the scope of the search mode, the second controller 20 initially loads the loss position VP.

In a sixth method step S6, the second controller 20 checks whether the smartphone 4 is situated within a given distance value around the loss position VP. If this is not the case, the second controller 20 indicates the loss position VP or at least a direction and separation from the latter to the user, so that the user can make their way to that position. If the smartphone 4 is situated within the specified distance value around the loss position, the second controller 20 transmits a first trigger signal by means of the BLE module 22 in a seventh method step S7, in order to reestablish the narrowband connection with the hearing device 2. If the BLE module 14 of the hearing device 2 responds and consequently reestablishes the narrowband connection, then the second controller 20 uses the respective BLE signals, specifically their signal strengths, to determine a distance value between the hearing device 2 and the smartphone 4 as an approximate indication and output this to the user as well.

If the user subsequently does not find the hearing device 2, the user is able to activate a fine search mode. Within the scope of the latter, the second controller activates the UWB module 24 in an eighth method step S8 and transmits a second trigger signal, which triggers the signal processor 6 of the hearing device 2 to activate the UWB module 16 of the hearing device 2, by means of the BLE module 22. Subsequently the signal processor 6 and the second controller 20 establish a wideband connection by means of the UWB modules 16 and 24.

In a ninth method step S9, the second controller 20 uses a signal time-of-flight measurement of the UWB signals to determine a distance value between the smartphone 4 and the hearing device 2 and a direction, for example by virtue of the second controller 20 requesting the user to rotate or swivel about their own axis with the smartphone 4. The rotational position at which the smallest distance value from the hearing device 2 is determined is used as directional information, and the directional information and the distance value are indicated to the user. Since the spatial resolution is particularly precise on the basis of the signal time-of-flight measurement, there is a particularly high probability of the user retrieving the hearing device 2.

In the case of the exemplary embodiment depicted in FIG. 2, the procedure described above on the basis of FIGS. 1 and 3 is implemented in the same way for the case that the user has misplaced the charger 30. In this case, the hearing device 2, the signal processor 6, and the BLE and UWB modules 14 and 16 are replaced analogously by the charger 30, its third controller 32, and its BLE and UWB modules 34 and 36. In addition to the satellite-based determination, the determination of the position by means of the position detection system 26 can also be assisted by auxiliary measures, for example an identified connection to a WLAN router or other equipment. As a result, the spatial resolution within enclosed spaces can be increased in the manner known per se.

The subject matter of the invention is not restricted to the above-described exemplary embodiments. Rather, further embodiments of the invention can be derived by a person skilled in the art from the above description. In particular, the individual features of the invention described on the basis of the various exemplary embodiments and their design variants can also be combined with one another in another way.

### LIST OF REFERENCE SIGNS

1 Hearing device system
2 Hearing device
4 Smartphone
6 Signal processor
8 Microphone
10 Loudspeaker
12 Battery
14 BLE module
16 UWB module
20 Controller
22 BLE module
24 UWB module
26 Position detection system
30 Charger
32 Controller
34 BLE module
36 UWB module
40 Display
S1-S9 Method step
VP Loss position

1-11. (canceled)

12. A hearing device system, comprising
a hearing device having a first wideband communications apparatus, a first narrowband communications apparatus, and a first controller interconnected therewith;
a mobile terminal having a second wideband communications apparatus, a second narrowband communications apparatus, a position detection system, and a second controller interconnected therewith;
said first and second controllers being configured to establish and maintain a narrowband connection between said hearing device and said mobile terminal by way of said first and second narrowband communications apparatus during an intended normal operation;
said second controller being configured to determine and store a current position of said mobile terminal as a loss position of said hearing device using said position detection system when the narrowband connection with said hearing device is disconnected;
said second controller being configured to display the stored loss position to a user, at least in a search mode activated by a user input; and
said second controller being configured, in the search mode, to establish a wideband connection with said hearing device by way of said second wideband communications apparatus and to derive and output to the user an indication for an actual position of the hearing device based on the wideband connection.

13. The hearing device system according to claim 12, wherein said second controller is configured to determine a distance value between said mobile terminal and said hearing device on a basis of the existing narrowband connection with said hearing device, to deduce an absence of said hearing device when the distance value is greater than a specified limit value, and to determine the loss position of said hearing device when the absence has been determined.

14. The hearing device system according to claim 12, wherein said second controller is configured, within a scope of the search mode, to reestablish the narrowband connection between said hearing device and said mobile terminal by way of the second narrowband communications apparatus when said mobile terminal is situated within a given distance range around the determined loss position.

15. The hearing device system according to claim 14, wherein said second controller is configured to derive an approximate indication for the actual position of said hearing device on a basis of the narrowband connection.

16. The hearing device system according to claim 12, wherein said second controller is configured to output directional information and distance information as indication or approximate indication.

17. The hearing device system according to claim 12, wherein said second controller is configured, within a scope of the search mode, to establish the wideband connection following a user-specific input.

18. The hearing device system according to claim 12, wherein:
wherein said second controller is configured, within a scope of the search mode, to reestablish the narrowband connection between said hearing device and said mobile terminal by way of the second narrowband communications apparatus when said mobile terminal is situated within a given distance range around the determined loss position; and
said second controller is configured, within the scope of the search mode, to transmit a trigger signal to the hearing device by way of the narrowband connection, for establishing the wideband connection.

19. The hearing device system according to claim 12, wherein said first and second narrowband communications apparatus are configured to operate with Bluetooth Low Energy radio communications.

20. The hearing device system according to claim 19, wherein said first and second wideband communications apparatus are configured to transmit signals with a frequency width of at least 500 MHz and/or at least 20% of a mid-frequency of the signals.

21. The hearing device system according to claim 20, wherein said wideband communications apparatus are configured to transmit signals with a pulse duration of less than or equal to 3 ns.

22. The hearing device system according to claim 20, wherein said wideband communications apparatus are ultrawideband wideband communications apparatus.

23. The hearing device system according to claim 20, wherein said second controller is configured to determine the distance between said terminal and said hearing device based on a signal time-of-flight measurement or a signal angle of arrival.

24. The hearing device system according to claim 23, wherein said first controller and said second controller are configured to determine the distance between said terminal and said hearing device based on a signal time-of-flight measurement or a signal angle of arrival.

25. A hearing device system, comprising:
a hearing device;
a mobile terminal having a second wideband communications apparatus, a second narrowband communications apparatus, a position detection system, and a second controller interconnected therewith; and
a charger for said hearing device, said charger having a third wideband communications apparatus, a third narrowband communications apparatus, and a third controller interconnected therewith;
said second and third controllers being configured to establish and maintain a narrowband connection between said mobile terminal and said charger by way of said second and third narrowband communications apparatus during an intended normal operation;
said second controller being configured to determine and store a current position of said mobile terminal as a loss position of said charger using said position detection system when the narrowband connection with said charger is disconnected;
said second controller being configured to display the stored loss position to a user, at least in a search mode activated by a user input, and said second controller being configured, within a scope of the search mode, to establish a wideband connection with said charger by way of said second wideband communications apparatus, and to derive and output to the user an indication for an actual position of said charger based on the wideband connection.

26. The hearing device system according to claim 25, wherein said second and third narrowband communications apparatus are configured to operate with Bluetooth Low Energy radio communications.

27. The hearing device system according to claim 25, wherein said second and third wideband communications apparatus are configured to transmit signals with a frequency width of at least 500 MHz and/or at least 20% of a mid-frequency of the signals.

28. The hearing device system according to claim 27, wherein said wideband communications apparatus are configured to transmit signals with a pulse duration of less than or equal to 3 ns.

29. The hearing device system according to claim 27, wherein said wideband communications apparatus are ultrawideband wideband communications apparatus.

30. The hearing device system according to claim 27, wherein said second controller is configured to determine the distance between said terminal and said charger based on a signal time-of-flight measurement or a signal angle of arrival.

31. The hearing device system according to claim 30, wherein said second controller and said third controller are configured to determine the distance between said terminal and said charger based on a signal time-of-flight measurement or a signal angle of arrival.
